(19) United States
(12) Patent Application Publication
(10) Pub. No.: US 2004/0009252 A1
(43) Pub. Date: Jan. 15, 2004

(54) Injection molding machine with electric components linked in wireless mode

(75) Inventors: Ulrich Reichstein, Wiehe (DE); Oswald Dachs, Eckental (DE); Gerd Warnecke, Naumburg (DE); Bodo Stange, Thalmassing (DE); Matthias Kanter, Obertrebra (DE)

Correspondence Address: Henry M. Feiereisen, Suite 4714, 350 Fifth Avenue, New York, NY, 10118, US

(73) Assignee: DEMAG ERGOTECH GMBH, Schwaig (DE)

(21) Appl. No.: 10/603,459

(22) Filed: Jun. 25, 2003

(30) Foreign Application Priority Data
Jun. 25, 2002 (DE) 102 28 250.1-51

(51) Int. Cl. B29C 45/76; B29C 47/92; B29C 49/78

(52) U.S. Cl. 425/143; 425/149; 425/162

(57) ABSTRACT

A machine for making formed articles of plastic or rubber, such as an injection molding machine, extruder or blow molding machine, includes a machine control, and a plurality of electric components which are operatively connected through wireless communication to the machine control. The machine control as well as the electric components have each devices for transmitting and receiving electromagnetic waves.

### CROSS-REFERENCES TO RELATED APPLICATIONS

This application claims the priority of German Patent Application, Serial No. 102 28 250.1-51, filed Jun. 25, 2002, pursuant to 35 U.S.C. 119(a)-(d), the disclosure of which is incorporated herein by reference.

### BACKGROUND OF THE INVENTION

The present invention relates, in general, to a machine of making molded articles of plastic or rubber, e.g. an injection molding machine, extruder or blow molding machine.

An injection molding machine has typically a plurality of electric components which are operatively connected to a machine control having a microprocessor for controlling the process sequence of the injection molding machine. The individual electric components are hereby connected to the machine control and/or an external computer by cables.

German patent publication DE 199 58 790 A1 describes a control system to regulate the temperature of a heater in response to signals generated by sensors. The control system, heater and sensors are linked to one another by connections having an electric unit which includes a field bus terminal in addition to the sensor for detecting the actual temperature. The electric unit is connected via a field bus to the remotely located control system. All electric components are connected to the control system by cables

The provision of cables to connect electric components of an injection molding machine greatly limits the freedom of design, when constructing the machine. Care must be taken to prevent a contact of the cables with hot machine components, since otherwise the cable insulation may melt. Another concern is the risk of damage to the cables, during travel of machine parts of the injection molding machine, e.g. the clamping unit, as the cables are moved at the same time. Therefore, the cables are typically placed in a so-called trailing cable installation.

It would therefore be desirable and advantageous to provide an improved machine of making molded articles, such as an injection molding machine, to obviate prior art shortcomings and to minimize the use of cables.

### SUMMARY OF THE INVENTION

According to one aspect of the present invention, a machine of making molded articles of plastic or rubber, such as an injection molding machine, extruder or blow molding machine, includes a machine control, and a plurality of electric components which are operatively connected through wireless communication to the machine control, wherein the machine control and the electric components have devices for transmitting and receiving electromagnetic waves.

The present invention resolves prior art problems by allowing hardware connections (e.g., cable connections) between components to be replaced with a wireless transmission of signals so that the machine and the electric components on the machine can be designed substantially free of any constraints. There is no need to take into account the position of cables and there is no need for provision of a trailing cable installation. As a consequence, assembly of the machine is significantly facilitated so that the production can commence at a much quicker rate.

According to another feature of the present invention, the wireless communication may be configured to comply with Bluetooth wireless specification. The Bluetooth wireless technology provides a technology specification for short-range radio links in the 2.4 GHz ISM band and is a standard for wireless communication.

According to another feature of the present invention, the plurality of electric components may include a detector, e.g. a temperature sensor, displacement sensor, pressure sensor, or the like, wherein the detector includes a converter for converting a measuring signal into a signal transmittable in wireless mode.

According to another feature of the present invention, there may be provided at least one external device, e.g. PC or printer, which is linked in wireless mode to the machine control.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic block diagram of components of an exemplified injection molding machine in accordance with the present invention;

FIG. 2 is a detailed illustration of an electric component for a thermoelement for use in the injection molding machine; and

FIG. 3 is a detailed illustration of another electric component for use in the injection molding machine.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

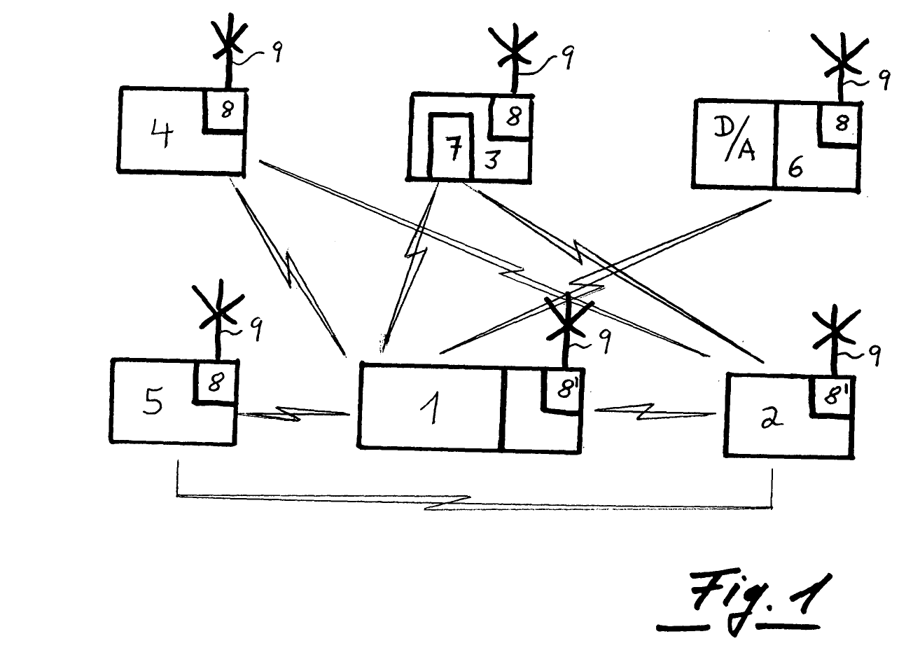

Turning now to the drawing, and in particular to FIG. 1, there is shown a schematic block diagram showing interacting components of a not shown injection molding machine. The injection molding machine includes a central machine control 1, an operating terminal 2 as well as further electric components on various parts of the machine, such as a temperature sensor 7 in a hot runner 3, a length measuring system 4, and a pressure sensor 5. Ascertained machine data as measured by the electric components are printed by a printer 6 which is operatively connected to the machine control 1. Transmission of data between the electric components 2, 3, 4, 5, 6, and the machine control 1 is realized by wireless communication through use of signal converters 8, 8′ and antennas 9 for transmitting and receiving electromagnetic waves. An example of a suitable wireless technology includes Bluetooth wireless specification.

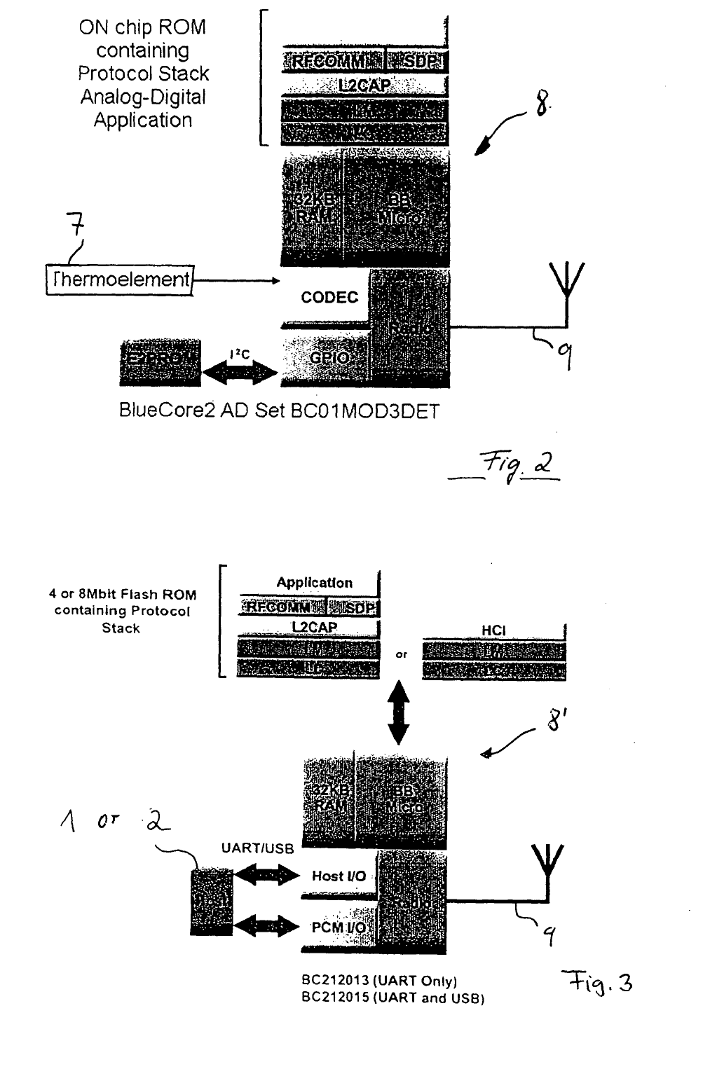

The data communication will now be described in more detail with reference to the operation of the temperature sensor in the form of the thermoelement 7. The thermoelement 7 measures the temperature of plastic melt in the hot runner 3 of the injection molding machine and generates as measuring value an output voltage. The signal converter 8 in thermoelement 7 executes an analog-to-digital conversion of the output voltage of the thermoelement 7 and transmits the measuring values to the machine control 1 and the operating terminal 2. An example of a suitable signal converter 8 is shown in FIG. 2 and is commercially available under the product name “BlueCore2 AD Set BC01 MOD4DET” through the company Cambridge Silicon Radio, United Kingdom. The measuring values are thus available for the machine control 1 to execute respective control tasks, and for the operating terminal 2 for display of the measuring values.

The signal converter 8′ in each of the machine control 1 and the operating terminal 2 is provided for sending and receiving data, and is shown in more detail in FIG. 3 and commercially available under the product name “BlueCore2 BC212015” through the company Cambridge Silicon Radio, United Kingdom.

Construction and manner of incorporation of the signal converters 8, 8′ are generally known to the artisan so that a detailed description thereof has been omitted for the sake of simplicity.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A machine of making molded articles of plastic or rubber, such as an injection molding machine, extruder or blow molding machine, comprising a machine control; and a plurality of electric components which are operatively connected through wireless communication to the machine control, wherein the machine control and the electric components have means for transmitting and receiving electromagnetic waves.

2. The machine of claim 1, wherein the wireless communication is configured to conform to Bluetooth wireless technology.

3. The machine of claim 1, wherein the plurality of electric components includes a detector selected from the group consisting of temperature sensor, displacement sensor, pressure sensor, wherein the detector includes a converter for converting a measuring signal into a signal transmittable in wireless mode.

4. The machine of claim 1, and further comprising at least one external device selected from the group consisting of PC and printer, and linked in wireless mode to the machine control.
